(19) United States
(12) Patent Application Publication
(10) Pub. No.: US 2018/0057961 A1
(43) Pub. Date: Mar. 1, 2018

(54) COMPUTATIONAL METHODS FOR DESIGNING POLYPEPTIDE LIBRARIES

(71) Applicant: IGC BIO, INC., Brookline, MA (US)

(72) Inventor: Lior ZIMMERMAN, Tel Aviv (IL)

(73) Assignee: IGC BIO, INC., Brookline, MA (US)

(21) Appl. No.: 15/685,611

(22) Filed: Aug. 24, 2017

Related U.S. Application Data
(60) Provisional application No. 62/380,176, filed on Aug. 26, 2016.

(51) Int. Cl. C40B 30/02

(52) U.S. Cl. CPC C40B 30/02

(57) ABSTRACT

The invention relates to systems and methods for generating a polypeptide library. Specifically, the invention relates to computer-implemented systems and methods for generating a library of polypeptides, for example, antibodies.

### FIELD OF THE INVENTION

The invention relates to systems and methods for generating a polypeptide library. Specifically, the invention relates to computer-implemented systems and methods for generating a library of polypeptides, for example, antibodies.

### BACKGROUND OF THE INVENTION

Monoclonal antibodies have been functioning as therapeutic, diagnostic and research agents since the 1970s. One of the major advancements of recent years, is the ability to develop and screen large antibody libraries for a specific target. This development is a consequence of phage display—a technology that enables the display of billions of proteins on top of the viral capsule. Phage display technology was followed by more technologies such as yeast display and ribosome display.

Previous antibody libraries were developed by amplifying human B cells or synthesizing a completely artificial library. Antibodies cloned from B cells may not represent the full diversity of the immune system and also may have a bias towards a certain clone of sequences. Synthetic libraries may produce immunogenic antibodies that can potentially trigger an immune response in patients.

Some libraries were constructed with human sequences. Although the sequences of these antibodies are human, they were not optimized for stability or developability and may raise problems upon reaching the clinical setting. The more such problems are recognized later in the process, the more costly it becomes.

Therapeutic antibodies have a high standard with regard to their developability, stability, immunogenicity, and functional activity. Previous generation antibody libraries, although large in number, could not accurately account for the vast majority of molecules in terms of stability and developability. These qualities were only determined once the antibody was screened and tested. Given that sorting methods (e.g., flow-cytometry or phage display) are known to be bound by approximately 10⁷ (flow cytometry) to 10¹¹ (phage display) variants, a reliable antibody library should be optimized in a way to maximize that every construct is developable and non-immunogenic, as well as be optimized for stability and binding specificity, to lower the probability of failure in later stages.

Accordingly, there exists a need for improved systems and methods for generating antibody libraries.

### SUMMARY OF THE INVENTION

In one aspect, provided herein are computer implemented methods for generating a library of polypeptides or antibodies, the methods comprise: obtaining a first amino acid sequence of a complementarity determining region (CDR) associated with a heavy chain and a second amino acid sequence of a CDR associated with a light chain from a database of CDR sequences; obtaining one or more variable heavy (VH) and variable light (VL) structural framework (VH/VL) pairs, wherein each of said pairs having one or more predetermined developability properties that facilitate for screening antibodies; and analyzing said amino acid sequences and said VH/VL pairs with the use of a macromolecular algorithmic unit to generate one or more structures. In an exemplary embodiment, the macromolecular algorithmic unit modifies or optimizes the amino acid sequence based on a Point Specific Scoring Matrix (PSSM).

In another aspect, provided herein are systems for generating a library of polypeptides or antibodies, the systems comprise: a complementarity determining region (CDR) unit that facilitates obtaining a first amino acid sequence of a CDR associated with a heavy chain and a second amino acid sequence of a CDR associated with a light chain from a database of CDR sequences; a framework unit that facilitates obtaining one or more variable heavy (VH) and variable light (VL) structural framework (VH/VL) pairs, wherein each of said pairs having one or more predetermined developability properties that facilitate for screening antibodies; and an analysis unit that facilitates analyzing said amino acid sequences and said VH/VL pairs with the use of a macromolecular algorithmic unit to generate one or more structures.

In another aspect, provided herein are computer readable storage media comprising instructions to perform a method for generating a library of polypeptides or antibodies, the method comprising: obtaining a first amino acid sequence of a complementarity determining region (CDR) associated with a heavy chain and a second amino acid sequence of a CDR associated with a light chain from a database of CDR sequences; obtaining one or more variable heavy (VH) and variable light (VL) structural framework (VH/VL) pairs, wherein each of said pair having one or more predetermined developability properties that facilitate for screening antibodies; and analyzing said amino acid sequences and said VH/VL pairs with the use of a macromolecular algorithmic unit to generate one or more structures

Other features and advantages of the present invention will become apparent from the following detailed description examples and figures. It should be understood, however, that the detailed description and the specific examples while indicating preferred embodiments of the invention are given by way of illustration only, since various changes and modifications within the spirit and scope of the invention will become apparent to those skilled in the art from this detailed description.

### BRIEF DESCRIPTION OF THE DRAWINGS

The invention will be better understood from a reading of the following detailed description taken in conjunction with the drawings in which like reference designators are used to designate like elements:

FIG. 1 illustrates a system for generating a library of antibodies, according to one embodiment of the invention.

FIG. 2 illustrates a flow chart of a method for generating a library of antibodies, according to one embodiment of the invention.

FIG. 3 illustrates a schematic detailing, according to one embodiment of the invention, a process of designing a library of polynucleotides comprising the steps of Point Specific Scoring Matrix sequence generation and post developability and immunogenicity filtering.

FIG. 4 illustrates a schematic detailing, according to one embodiment of the invention, a process of designing a library of polynucleotides comprising the steps of computational Point Specific Scoring Matrix (PSSM) directed design and post developability and immunogenicity filtering.

FIG. 5 illustrates a schematic detailing, a schematic detailing, according to one embodiment of the invention, a process of designing a library of polynucleotides comprising the steps of computational Point Specific Scoring Matrix (PSSM) directed design and Post developability filtering and diversity amplification.

FIG. 6 illustrates a schematic detailing, according to one embodiment of the invention, a process of designing a library of polynucleotides comprising the steps of computational Point Specific Scoring Matrix (PSSM) directed design and energy score which includes developability criterion.

FIG. 7 illustrates a schematic detailing, according to one embodiment of the invention, a process of designing a library of polynucleotides comprising the steps of computational Point Specific Scoring Matrix (PSSM) directed design and energy score which includes developability criterion and diversity amplification.

FIG. 8 illustrates a schematic detailing, according to one embodiment of the invention, a process of designing a library of polynucleotides comprising the steps of computational Point Specific Scoring Matrix (PSSM) directed design guided by alignment based sampling and post developability and immunogenicity filtering.

FIG. 9 illustrates a schematic detailing, according to one embodiment of the invention, a process of designing a library of polynucleotides comprising the steps of computational Point Specific Scoring Matrix (PSSM) directed design guided by alignment based sampling and Post developability filtering and diversity amplification.

FIG. 10 illustrates a schematic detailing, according to one embodiment of the invention, a process of designing a library of polynucleotides comprising the steps of computational Point Specific Scoring Matrix (PSSM) directed design guided by alignment based sampling and energy score which includes developability criterion.

FIG. 11 illustrates a schematic detailing, according to one embodiment of the invention, a process of designing a library of polynucleotides comprising the steps of computational Point Specific Scoring Matrix (PSSM) directed design guided by alignment based sampling and energy score which includes developability criterion and diversity amplification.

FIG. 12 shows developability properties used for screening, according to one embodiment of the invention.

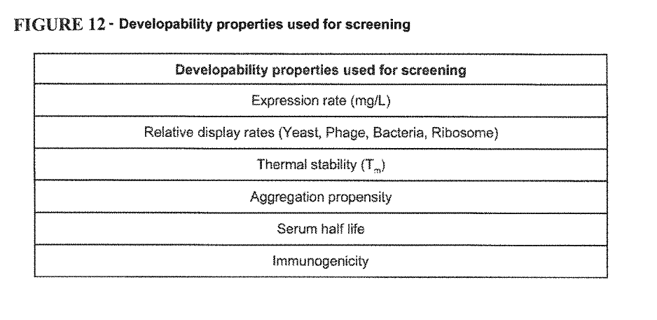

FIG. 13 shows germline configuration of an antibody molecule.

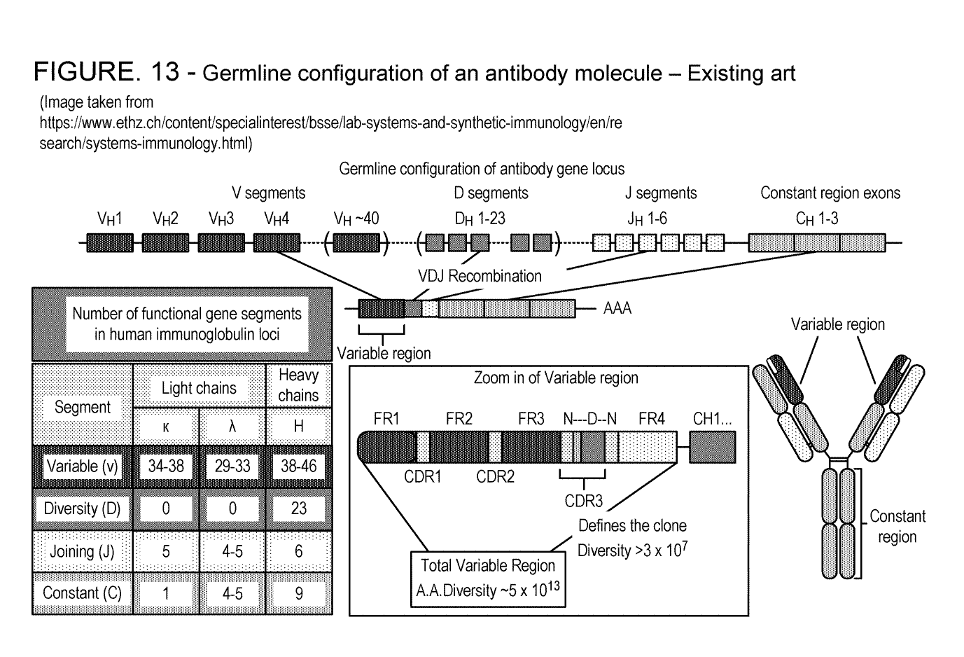

FIG. 14 shows a schematic drawing of an antibody molecule.

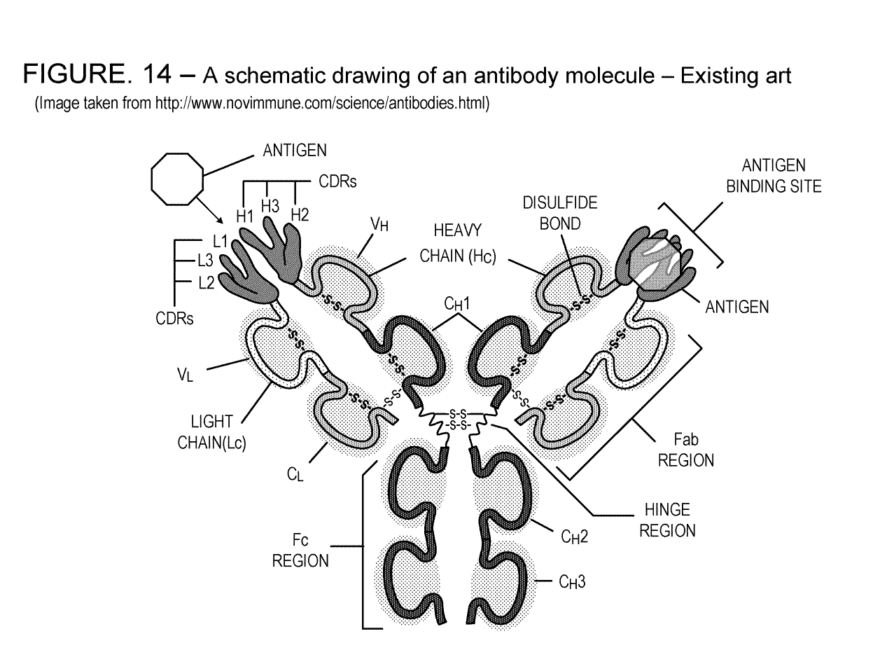

FIG. 15 shows examples of antibody models outputs, according to one embodiment of the invention.

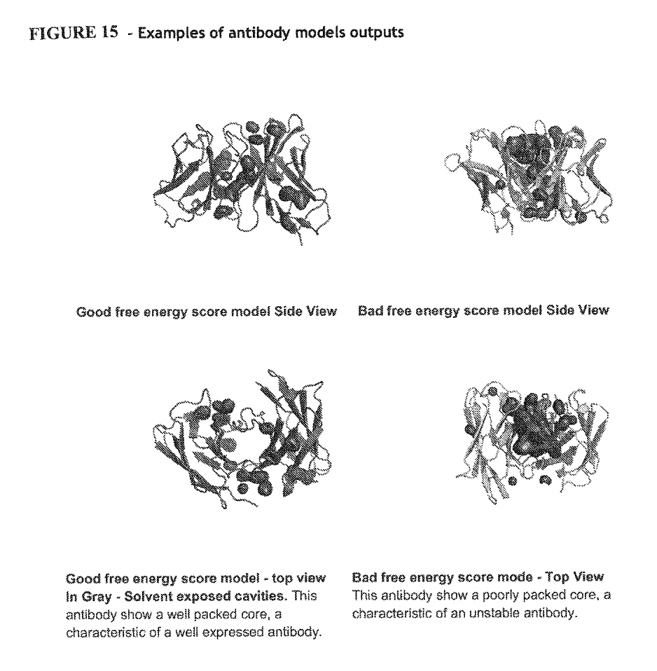

FIG. 16 shows a schematic detailing the process of PSSM refinement from experimental data.

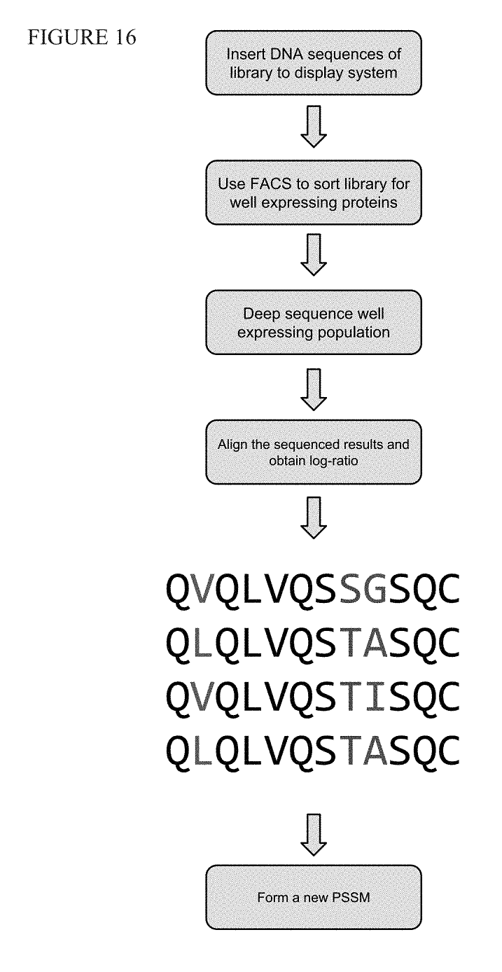

### DETAILED DESCRIPTION OF THE INVENTION

The invention provides systems and methods for generating a polypeptide library, for example, an antibody library. Specifically, the invention relates to computer-implemented systems and methods for generating a library of polypeptides, for example, antibodies.

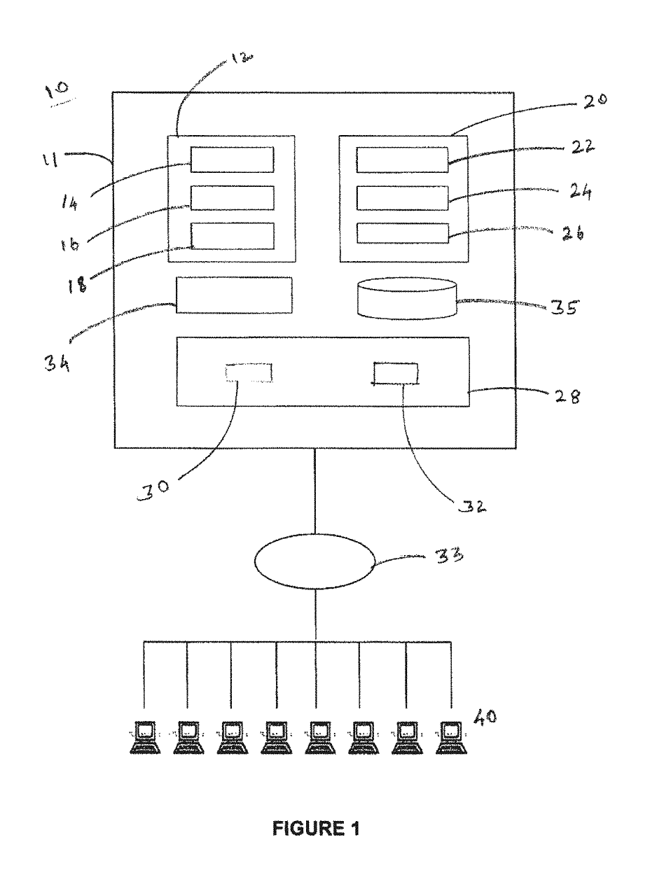

FIG. 1 schematically illustrates one arrangement of a system for generating a library. Although the FIG. 1 environment shows an exemplary conventional general-purpose digital environment, it will be understood that other computing environments may also be used. For example, one or more embodiments of the present invention may use an environment having fewer than or otherwise more than all of the various aspects shown in FIG. 1, and these aspects may appear in various combinations and sub-combinations that will be apparent to one of ordinary skill in the art.

As shown in FIG. 1, a user computer 10 can operate in a networked environment using logical connections to one or more remote computers, such as a remote server 11. The server 11 can be a web server, a router, a network PC, a peer device or other common network node, and typically includes many or all of the elements of a computer. It will be appreciated that the network connections shown in FIG. 1 are exemplary and other techniques for establishing a communications link between the computers can be used. The connection may include a local area network (LAN) and a wide area network (WAN). The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers, as well as non-web interfaces can be used to display and manipulate data.

In one aspect, a polypeptide library (e.g., an antibody library) can be generated in an online environment. As illustrated in FIG. 1, a user (e.g., researcher) 41 has a user computer 40 with Internet access that is operatively coupled to server 11 via a network 33, which can be an internet or intranet. User computer 40 and server 11 implement various aspects of the invention that is apparent in the detailed description. For example, user computer 40 may be in the form of a personal computer, a tablet personal computer or a personal digital assistant (PDA). Tablet PCs interpret marks made using a stylus in order to manipulate data, enter text, and execute conventional computer application tasks such as spreadsheets, word processing programs, and the like. User computer 40 is configured with an application program that communicates with server 11. This application program can include a conventional browser or browser-like programs.

In one embodiment, server 11 may include a plurality of programmed platforms or units, for example, but are not limited to, a seed generation platform 12, docking platform 20, design platform 28, and an epitope unit 34. Seed generation platform 12 may include one or more programmable units, for example, but are not limited to, a complementarity determining region (CDR) unit 14, a framework unit 16, and an analysis unit 18. Docking platform 20 may include a plurality of programmed platforms or units, for example, but are not limited to, a docking unit 22, an evaluation unit 24, and a selection unit 26. Design platform 28 may include a plurality of programmed platforms or units, for example, but are not limited to, a motif evaluation unit 30 and a library generation unit 32.

The term “platform” or “unit,” as used herein, may refer to a collection of programmed computer software codes for performing one or more tasks.

CDR unit 14 may facilitate a user to obtain a first amino acid sequence of a CDR associated with a heavy chain and a second amino acid sequence of a CDR associated with a light chain from a database 35 of CDR sequences. In one embodiment, the first amino acid sequence is an H3 sequence of CDR3. In another embodiment, the first amino acid sequence is an L3 sequence of CDR3. In one example database 35 is a CDR3 sequence database.

Framework unit 16 may facilitate a user to obtain one or more variable heavy (VH) and variable light (VL) structural framework (VH/VL) pairs. Each of the pair may have one or more predetermined developability properties that facilitate for screening antibodies. The predetermined developability properties may also facilitate for selecting one or more desirable VH/VL pairs. Examples of a predetermined developability property include, for example, but not limited to, expression rate (mg/L), relative display rate, hermal stability (Tₘ), aggregation propensity, serum half-life, immunogenicity, and viscosity. In a particular embodiment, the predetermined developability property is an immunogenicity.

Analysis unit 18 may facilitate analyzing the amino acid sequences and the VH/VL pairs with the use of a macromolecular algorithmic unit to generate one or more seed structures.

The macromolecular algorithmic unit may facilitate evaluating the amino acid sequence of H3 loop, L3 loop, or a combination thereof. The macromolecular algorithmic unit can be used to modify or optimize the amino acid sequence of H3 loop, L3 loop, or a combination thereof. In one embodiment, the amino acid sequence of H3 loop, L3 loop, or a combination thereof can be modified or optimized based on a Point Specific Scoring Matrix (PSSM). In another embodiment, the amino acid sequence of H3 loop, L3 loop, or a combination thereof can be modified or optimized based on one or more VH/VL pairs.

In one aspect, one or more seed structures are generated based on an energy function of H3 loop, L3 loop, VH/VL pair or a combination thereof. In another aspect, one or more seed structures are generated based on humanization of the structures.

Epitope unit 34 may facilitate providing a predetermined epitope. In one example, the epitope is determined based on a subset of a protein. In another example, the epitope has one or more residues that interact with its interacting partner at a predetermined distance. In one embodiment, the distance is <4 Å. Other suitable distances are also encompassed within the scope of the invention.

Docking unit 22 may facilitate docking one or more seed structures on the epitope. Evaluation unit 24 may facilitate for evaluating the docked seed structures for a shape complementarity and an epitope overlap.

Selection unit 26 may facilitate selecting one or more structures having a value exceeding a predetermined threshold level. In one embodiment, the predetermined threshold level is based on a shape complementarity score. In another embodiment, the predetermined threshold level is based on an epitope overlap score. In some embodiments, the predetermined threshold level is based a combination of a shape complementarity score and an epitope overlap score.

In some embodiments, one or more selected structures can be optimized using a simulated annealing process, which is an adaptation of the Monte Carlo method to generate sample states of a thermodynamic system. In another embodiment, the simulated annealing process is composed of rigid body minimization, antibody H3-L3 sequence optimization, optimizing the packing of interface and core, optimizing the backbone of antibody, optimizing the light and heavy chain orientation, optimizing the antibody as monomer, or a combination thereof.

Motif evaluation unit 30 may facilitate evaluating one or more motifs of the selected structures to determine whether one or more motifs exhibit a negative effect for one or more predetermined developability properties. In some embodiments, the one or more motifs with negative effects are removed. In a particular embodiment, an immunogenic motif is removed.

In one embodiment, CDR regions are mutated according to a Point Specific Scoring Matrix (PSSM) and the evaluation may be performed by evaluating an energy score that is derived from the algorithmic unit.

Library generation unit 32 may facilitate identifying one or more target structures based on the determination of any negative effect of one or more motifs in order to generate a library.

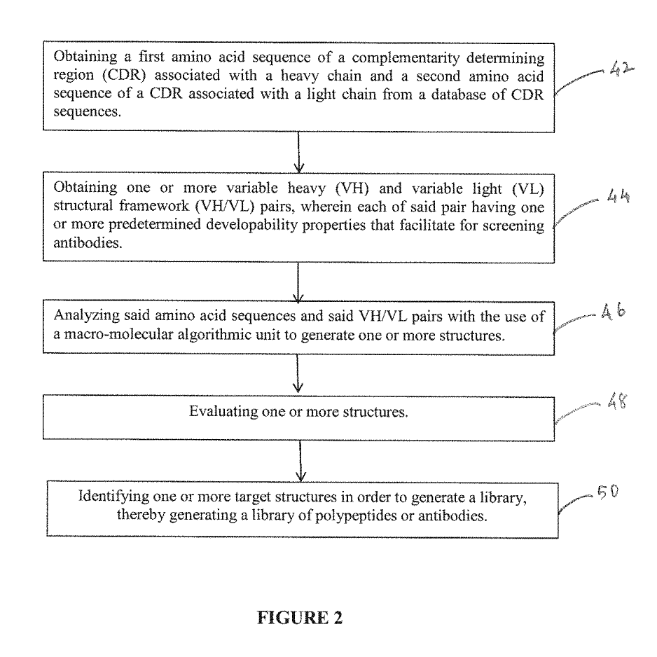

FIG. 2 illustrates a method for generating a library of antibodies, according to one embodiment of the invention. As shown in item 42, a first amino acid sequence of a CDR associated with a heavy chain and a second amino acid sequence of a CDR associated with a light chain can be obtained from database 35 of CDR sequences. As shown in item 44, one or more variable heavy (VH) and variable light (VL) structural framework (VH/VL) pairs can be obtained. Each of the pairs may have one or more predetermined developability properties that facilitate screening antibodies. As shown in item 46, the amino acid sequences and the VH/VL pairs can be analyzed with the use of a macromolecular algorithmic unit to generate one or more structures. As shown in item 48, evaluating one or more motifs of the selected structures can be evaluated to determine whether one or more motifs exhibit a negative effect for one or more predetermined developability properties. As shown in item 50, one or more target structures can be identified based on the determination of said negative effect of said one or more motifs in order to generate a library.

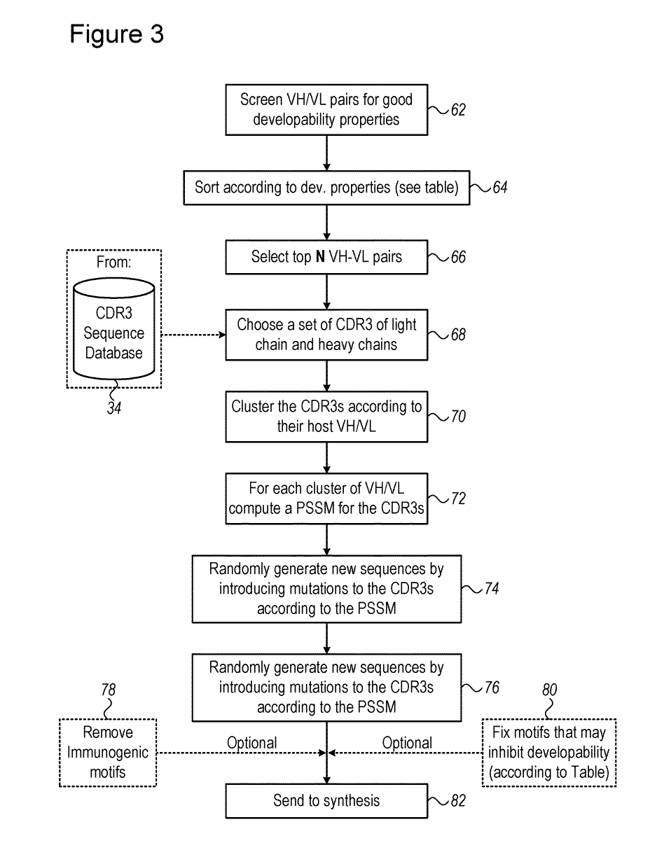

FIG. 3 shows a process of designing a library of polynucleotides comprising the steps of Point Specific Scoring Matrix sequence generation and post developability and immunogenicity filtering. As shown in item 62, VH/VL pairs can be screened for good developability properties. As shown in item 64, the screened out pairs can be sorted according to developability properties. As shown in item 66, the top N VH−VL pairs can be selected. As shown in item 68, a set of CDR3s of light chain and heavy chains can be chosen from CDR3 Sequence Database 34. As shown in item 70, the CDR3s can be clustered according to their host VH/VL. As shown in item 72, for each cluster of VH/VL, a PSSM can be computed for the CDR3s. As shown in item 74, new sequences can be randomly generated by introducing mutations to the CDR3s according to the PSSM. As shown in item 78, immunogenic motifs can be optionally removed. As shown in item 80, one or more motifs inhibiting developability can be optionally fixed. As shown in item 82, the structure can be sent to synthesis.

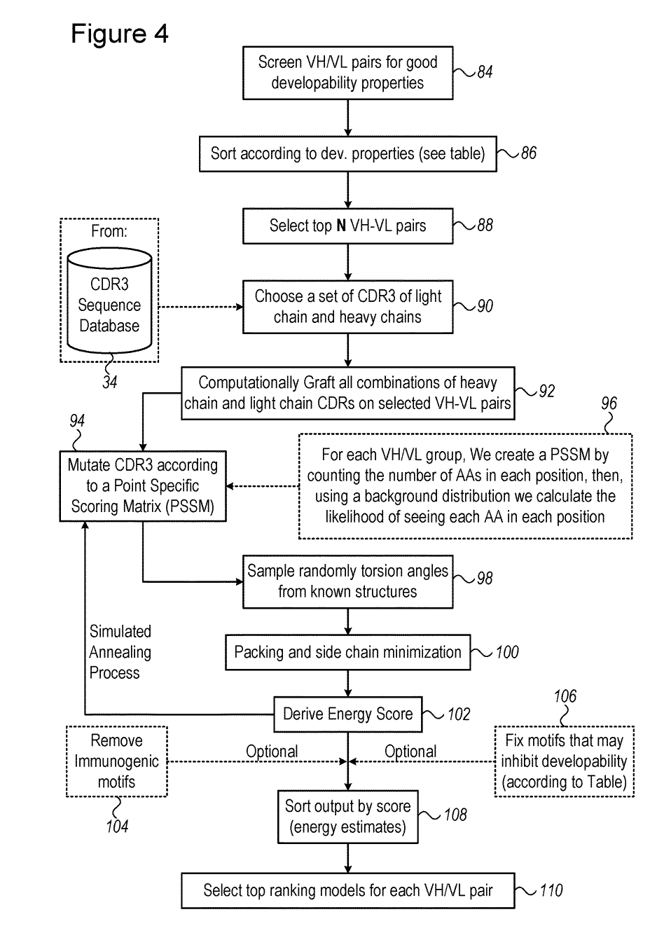

FIG. 4 shows a schematic detailing, according to another embodiment of the invention, a process of designing a library of polynucleotides comprising the steps of computational Point Specific Scoring Matrix (PSSM) directed design and post developability and immunogenicity filtering. As shown in item 84, VH/VL pairs can be screened for good developability properties. As shown in item 86, the screened out pairs can be sorted according to developability properties. As shown in item 88, top N VH−VL pairs can be selected. As shown in item 90, a set of CDR3 of light chain and heavy chains can be chosen from CDR3 Sequence Database 34. As shown in item 92, a plurality of combinations of heavy chain and light chain CDRs can be computationally grafted on selected VH/VL pairs. As shown in item 96, for each VH/VL group, a PSSM can be created by counting the number of amino acids in each position, and then, using a background distribution, the likelihood of seeing each amino acid in each position can be calculated. As shown in item 94, CDR3 can be mutated according to a Point Specific Scoring Matrix (PSSM). As shown in item 98, torsion angles from known structures can be sampled randomly. As shown in item 100, packing and side chain minimization can be facilitated. As shown in item 102, an energy score can be derived. As shown in item 104, immunogenic motifs can be removed. As shown in item 106, one or more motifs inhibiting developability can be optionally fixed. As shown in item 108, output can be sorted by score (e.g., energy estimates). As shown in item 110, top ranking models for each VH/VL pair can be selected.

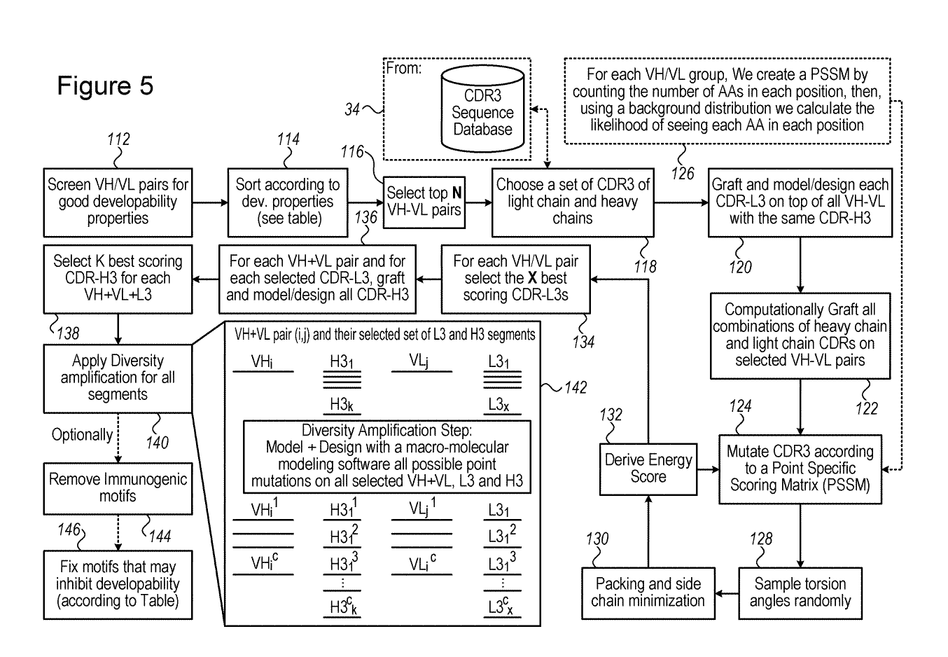

FIG. 5 shows a schematic detailing, a schematic detailing, according to another embodiment of the invention, a process of designing a library of polynucleotides comprising the steps of computational Point Specific Scoring Matrix (PSSM) directed design and Post developability filtering and diversity amplification. As shown in item 112, VH/VL pairs can be screened for good developability properties. As shown in item 114, the screened out pairs can be sorted according to developability properties. As shown in item 116, top N VH−VL pairs can be selected. As shown in item 118, a set of CDR3 of light chain and heavy chains can be chosen from CDR3 Sequence Database 34. As shown in item 120, each CDR-L3 can be grafted and modeled on top of all VH/VL with the same CDR-H3. As shown in item 122, a plurality of combinations of heavy chain and light chain CDRs can be computationally grafted on selected VH/VL pairs. As shown in item 124, CDR3 can be mutated according to a Point Specific Scoring Matrix (PSSM). In some embodiments, as shown in item 126, for each VH/VL group, a PSSM can be created by counting the number of amino acids in each position, and then, using a background distribution, the likelihood of seeing each amino acid in each position can be calculated. As shown in item 128, torsion angles can be randomly sampled. As shown in item 130, packing and side chain minimization can be facilitated. As shown in item 132, an energy score can be derived. As shown in item 134, for each VH/VL pair, one or more best scoring CDR-L3s can be selected. As shown in item 136, for each VH+VL pair and for each selected CDR-L3, a plurality of CDR-H3 can be grafted and modeled/designed. As shown in item 138, a best scoring CDR-H3 can be selected for each VH+VL+L3. As shown in item 140, diversity amplification can be applied for a plurality of segments. As shown in item 142, diversity amplification step may include a plurality of point mutations can be modeled and designed on a plurality of selected VH+VL, L3 and H3 with macromolecular modeling software. As shown in item 144, one or more immunogenic motifs can be removed. As shown in item 146, one or more motifs inhibiting developability can be optionally fixed.

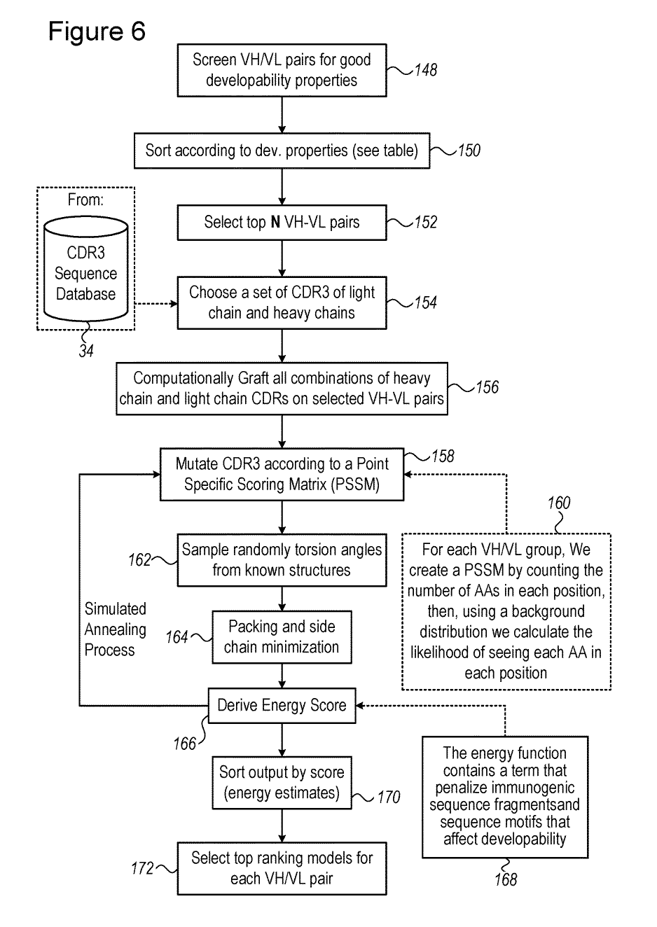

FIG. 6 shows a schematic detailing, according to another embodiment of the invention, a process of designing a library of polynucleotides comprising the steps of computational Point Specific Scoring Matrix (PSSM) directed design and energy score which includes developability criterion. As shown in item 148, VH/VL pairs can be screened for good developability properties. As shown in item 150, the screened out pairs can be sorted according to developability properties. As shown in item 152, top N VH−VL pairs can be selected. As shown in item 154, a set of CDR3 of light chain and heavy chains can be chosen from CDR3 Sequence Database 34. As shown in item 156, a plurality of combinations of heavy chain and light chain CDRs can be computationally grafted on selected VH/VL pairs. As shown in item 160, for each VH/VL group, a PSSM can be created by counting the number of amino acids in each position, and then, using a background distribution, the likelihood of seeing each amino acid in each position can be calculated. As shown in item 158, CDR3 can be mutated according to a Point Specific Scoring Matrix (PSSM). As shown in item 162, torsion angles from known structures can be sampled randomly. As shown in item 164, packing and side chain minimization can be facilitated. As shown in item 166, an energy score can be derived. As shown in item 168, the energy function may contain a term that penalize immunogenic sequence fragments and sequence motifs that affect developability. As shown in item 170, output can be sorted by score (e.g., energy estimates). As shown in item 172, top ranking models can be selected for each VH/VL pair.

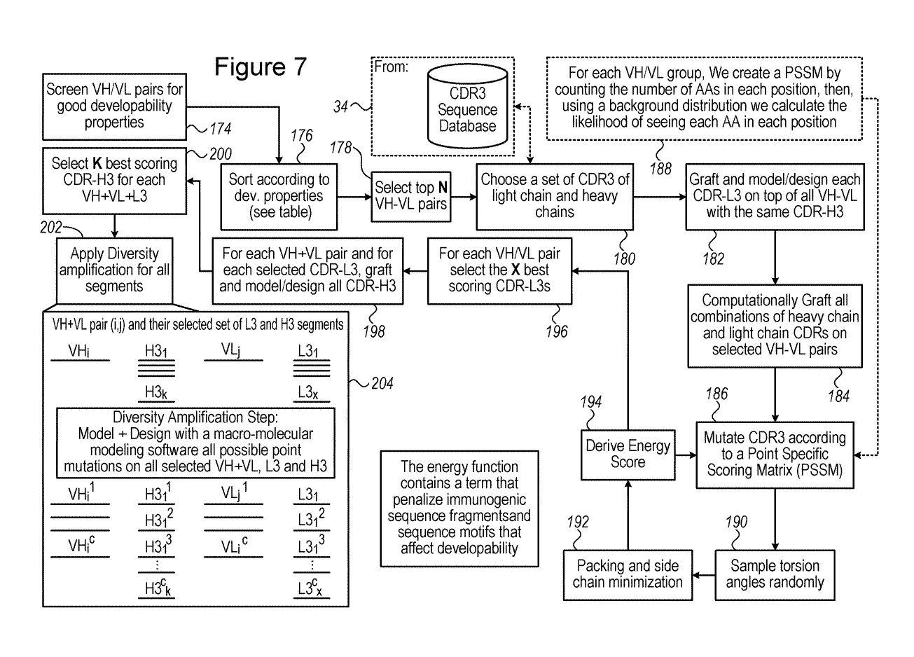

FIG. 7 shows a schematic detailing, according to another embodiment of the invention, a process of designing a library of polynucleotides comprising the steps of computational Point Specific Scoring Matrix (PSSM) directed design and energy score which includes developability criterion and diversity amplification. As shown in item 174, VH/VL pairs can be screened for good developability properties. As shown in item 176, the screened out pairs can be sorted according to developability properties. As shown in item 178, top N VH−VL pairs can be selected. As shown in item 180, a set of CDR3 of light chain and heavy chains can be chosen from CDR3 sequence database 34. As shown in item 182, each CDR-L3 can be grafted and modeled/designed on top of all VH−VL with the same CDR-H3. As shown in item 184, a plurality of combinations of heavy chain and light chain CDRs can be computationally grafted on selected VH−VL pairs. As shown in item 186, CDR3 can be mutated according to a Point Specific Scoring Matrix (PSSM). As shown in item 188, for each VH/VL group, a PSSM can be created by counting the number of amino acids in each position, and then, using a background distribution, the likelihood of seeing each amino acid in each position can be calculated. As shown in item 190, torsion angles can be sampled randomly. As shown in item 192, packing and side chain minimization can be performed. As shown in item 194, an energy score can be derived. The energy function may contain a term or a unit that penalizes immunogenic and sequence motifs that affect developability. As shown in item 196, for each VH/VL pair, one or more best scoring CDR-L3s can be selected. As shown in item 198, for each VH+VL pair and for each selected CDR-L3, a plurality of CDR-H3 can be grafted and modeled/designed. As shown in item 200, one or more best scoring CDR-H3 can be selected for each VH+VL+L3. As shown in item 202, diversity amplification can be applied for a plurality of segments. As shown in item 204, a plurality of point mutations on all selected VH+VL, L3 and H3 can be modeled and designed with macromolecular modeling software.

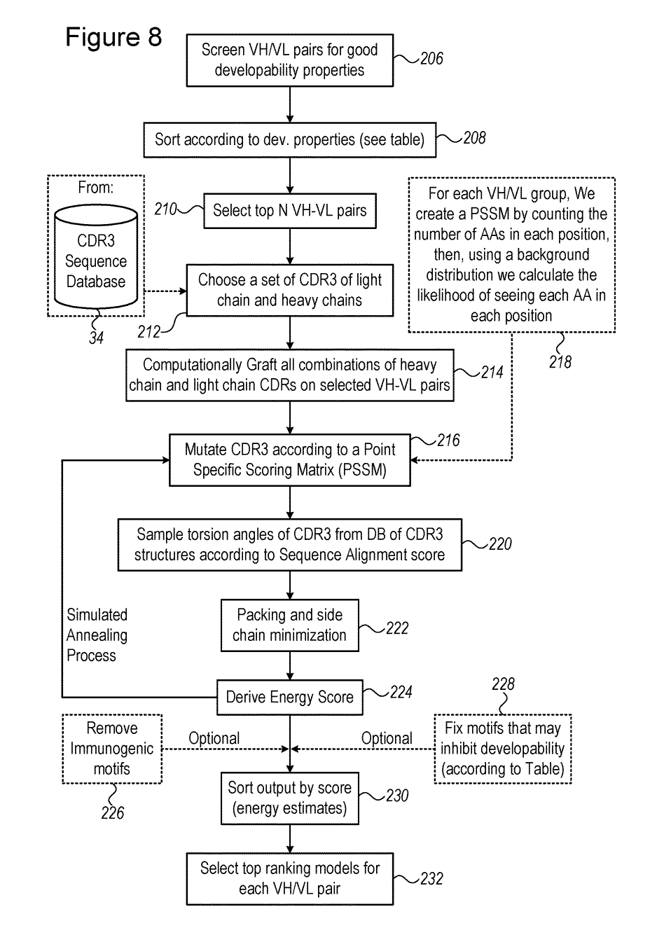

FIG. 8 shows a schematic detailing, according to another embodiment of the invention, a process of designing a library of polynucleotides comprising the steps of computational Point Specific Scoring Matrix (PSSM) directed design guided by alignment based sampling and post developability and immunogenicity filtering. As shown in item 206, VH/VL pairs for can be screened for good developability properties. As shown in item 208, the screened out pairs can be sorted according to one or more developability properties. As shown in item 210, one or more top VH/VL pairs can be selected. As shown in item 212, a plurality of CDR3 of light chain and heavy chains can be chosen from CDR Sequence Database 34. As shown in item 214, one or more combinations of heavy chain and light chain CDRs can be computationally grafted on one or more selected VH/VL pairs. As shown in item 216, CDR3 can be mutated according to a Point Specific Scoring Matrix (PSSM). As shown in item 218, for each VH/VL group, a PSSM can be created by counting the number of amino acids in each position, and then, using a background distribution, the likelihood of seeing each amino acid in each position can be calculated. As shown in item 220, torsion angles of CDR3 from DB of CDR3 structures can be sampled according to a Sequence Alignment score. As shown in item 222, packing and side chain minimization can be performed. As shown in item 224, energy score can be derived. As shown in item 226, one or more immunogenic motifs can be optionally removed. As shown in item 228, one or more motifs inhibiting developability can be optionally fixed. As shown in item 230, output can be sorted by a score (e.g., energy estimate). As shown in item 232, one or more top ranking models can be selected for each VH/VL pair.

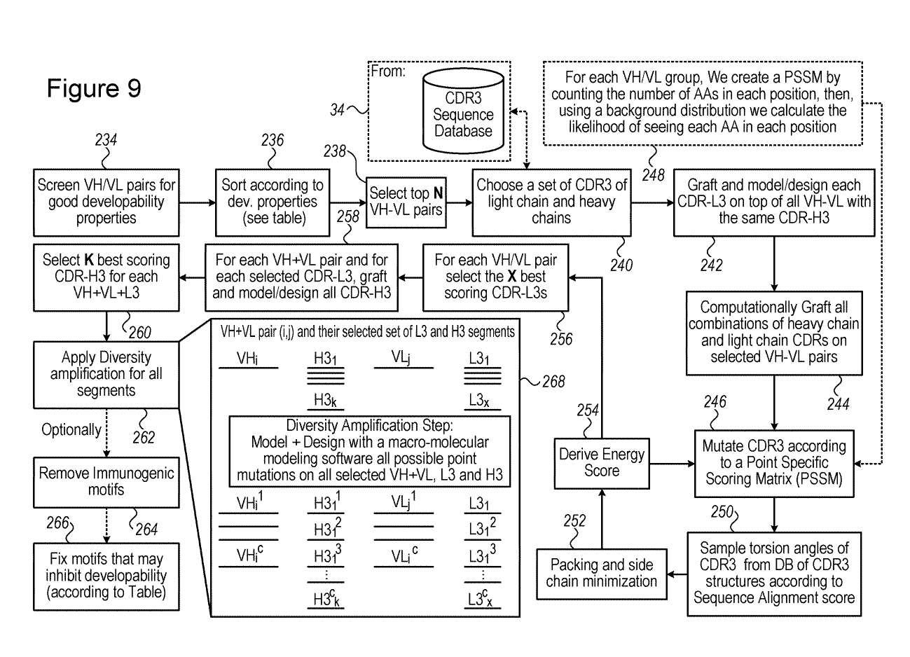

FIG. 9 shows a schematic detailing, according to another embodiment of the invention, a process of designing a library of polynucleotides comprising the steps of computational Point Specific Scoring Matrix (PSSM) directed design guided by alignment based sampling and Post developability filtering and diversity amplification. As shown in item 234, VH/VL pairs for can be screened for good developability properties. As shown in item 236, the screened out pairs can be sorted according to one or more developability properties. As shown in item 238, one or more top VH/VL pairs can be selected. As shown in item 240, a plurality of CDR3 of light chain and heavy chains can be chosen from CDR Sequence Database 34. As shown in item 242, each CDR-L3 can be grafted and modeled/designed on top of one or more of VH/VL with the same CDR-H3. As shown in item 244, one or more combinations of heavy chain and light chain CDRs can be computationally grafted on one or more selected VH/VL pairs. As shown in item 246, CDR3 can be mutated according to a Point Specific Scoring Matrix (PSSM). As shown in item 248, for each VH/VL group, a PSSM can be created by counting the number of amino acids in each position, and then, using a background distribution, the likelihood of seeing each amino acid in each position can be calculated. As shown in item 250, torsion angles of CDR3 from DB of CDR3 structures can be sampled according to a Sequence Alignment score. As shown in item 252, packing and side chain minimization can be performed. As shown in item 254, energy score can be derived. As shown in item 256, for each VH/VL pair, one or more best scoring CDR-L3s can be selected. As shown in item 258, for each VH+VL pair and for each selected CDR-L3, a plurality of CDR-H3 can be grafted and modeled/designed. As shown in item 260, one or more best scoring CDR-H3 can be selected for each VH+VL+L3. As shown in item 262, diversity amplification can be applied for a plurality of segments. As shown in item 268, a plurality of point mutations on all selected VH+VL, L3 and H3 can be modeled and designed with macromolecular modeling software. As shown in item 264, one or more immunogenic motifs can be removed. As shown in item 266, one or more motifs inhibiting developability can be optionally fixed.

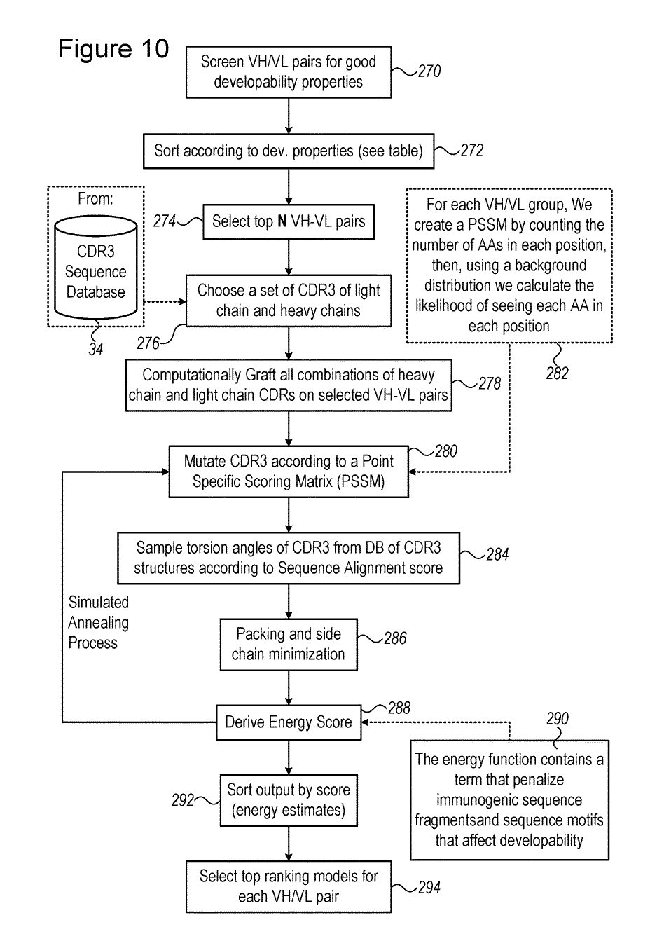

FIG. 10 shows a schematic detailing, according to another embodiment of the invention, a process of designing a library of polynucleotides comprising the steps of computational Point Specific Scoring Matrix (PSSM) directed design guided by alignment based sampling and energy score which includes developability criterion. As shown in item 270, VH/VL pairs for can be screened for good developability properties. As shown in item 272, the screened out pairs can be sorted according to one or more developability properties. As shown in item 274, one or more top VH/VL pairs can be selected. As shown in item 276, a plurality of CDR3 of light chain and heavy chains can be chosen from CDR Sequence Database 34. As shown in item 278, one or more combinations of heavy chain and light chain CDRs can be computationally grafted on one or more selected VH/VL pairs. As shown in item 280, CDR3 can be mutated according to a Point Specific Scoring Matrix (PSSM). As shown in item 282, for each VH/VL group, a PSSM can be created by counting the number of amino acids in each position, and then, using a background distribution, the likelihood of seeing each amino acid in each position can be calculated. As shown in item 284, torsion angles of CDR3 from DB of CDR3 structures can be sampled according to a Sequence Alignment score. As shown in item 286, packing and side chain minimization can be performed. As shown in item 288, energy score can be derived. As shown in item 290, the energy function may contain a term that penalize immunogenic sequence fragments and sequence motifs that affect developability. As shown in item 292, output can be sorted by a score (e.g., energy estimate). As shown in item 294, one or more top ranking models can be selected for each VH/VL pair.

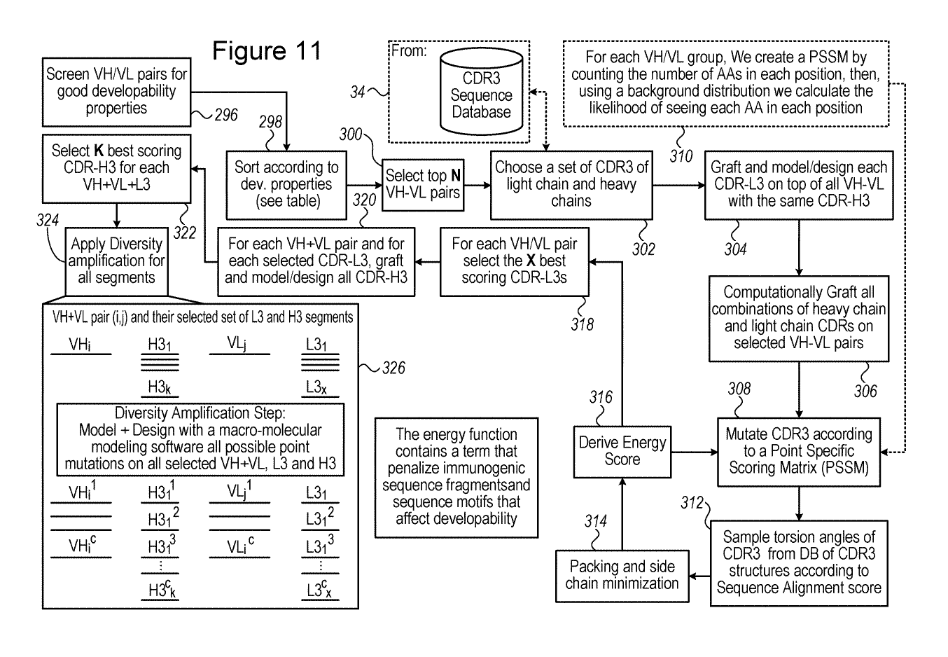

FIG. 11 shows a schematic detailing, according to another embodiment of the invention, a process of designing a library of polynucleotides comprising the steps of computational Point Specific Scoring Matrix (PSSM) directed design guided by alignment based sampling and energy score which includes developability criterion and diversity amplification. As shown in item 296, VH/VL pairs for can be screened for good developability properties. As shown in item 298, the screened out pairs can be sorted according to one or more developability properties. As shown in item 300, one or more top VH/VL pairs can be selected. As shown in item 302, a plurality of CDR3 of light chain and heavy chains can be chosen from CDR Sequence Database 34. As shown in item 304, each CDR-L3 can be grafted and modeled/designed on top of one or more of VH/VL with the same CDR-H3. As shown in item 306, one or more combinations of heavy chain and light chain CDRs can be computationally grafted on one or more selected VH/VL pairs. As shown in item 308, CDR3 can be mutated according to a Point Specific Scoring Matrix (PSSM). As shown in item 310, for each VH/VL group, a PSSM can be created by counting the number of amino acids in each position, and then, using a background distribution, the likelihood of seeing each amino acid in each position can be calculated. As shown in item 312, torsion angles of CDR3 from DB of CDR3 structures can be sampled according to a Sequence Alignment score. As shown in item 314, packing and side chain minimization can be performed. As shown in item 316, energy score can be derived. As shown in item 318, for each VH/VL pair, one or more best scoring CDR-L3s can be selected. As shown in item 320, for each VH+VL pair and for each selected CDR-L3, a plurality of CDR-H3 can be grafted and modeled/designed. As shown in item 322, one or more best scoring CDR-H3 can be selected for each VH+VL+L3. As shown in item 324, diversity amplification can be applied for a plurality of segments. As shown in item 326, a plurality of point mutations on all selected VH+VL, L3 and H3 can be modeled and designed with macromolecular modeling software.

### EXAMPLES

Embodiments of this invention utilize computational processing power to compute optimal antibody molecules. Provided herein are methods and systems to determine optimal antibody molecules that comprise the library (i.e, antibodies that are developable, stable and composed of human sequences). Given a computer system and macromolecular modeling software that is able to approximate the free energy of a protein molecule (aka free energy score, and/or score, which are used interchangeably herein). The following examples are presented in order to more fully illustrate the preferred embodiments of the invention. They should in no way be construed, however, as limiting the broad scope of the invention.

### Example 1

In one embodiment, the method for generating a polypeptide library include the following steps (See FIG. 2):
1. Screen human VH and VL pairings for good developability properties (See FIG. 10);
2. Sort VH−VL pairs according to the above parameters and a weighting vector (provide a weight for each of the parameters above);
3. Select top N ranking VH−VL pairs to serve as the basis (aka framework) for the antibody library;
4. Choose a data set of CDR-L3 and CDR-H3 sequences.
   Sizes can either be distributed uniformly or according to the human repertoire (can be inferred from a population of B-Cells);
5. Let |DB _{H3}|=R, |DB _{L3}|=T. Graft (See FIG. 2) each of the CDR-H3 and CDR-L3 from the data set on top of each of the selected frameworks (Cross product (VH+VL)×[H3_{1 . . . R}]×[L3_{1 . . . T}]);
6. Model+Design with macromolecular modeling software to obtain free energy estimates for each of the molecules;
   a. Optionally, the design process could include a motif elimination+replacement+score step that should improve the developability. (See Table 1 for motif elimination rules);
7. Rank end products by free energy estimates;
8. Optionally, after the design process, an immunogenicity filter could be applied that will fix/remove Abs with high probability of being immunogenic; and
9. For each VH−VL pair, Select top K molecules for synthesis.

### Example 2

In another embodiment, the method for generating a polypeptide library include the following steps (See FIG. 3):
1. Screen human VH and VL pairings for good developability properties (See FIG. 10);
2. Sort VH−VL pairs according to the above parameters and a weighting vector (provide a weight for each of the parameters above);
3. Select top N ranking VH−VL pairs to serve as the basis (aka framework) for the antibody library;
4. Choose a data set of CDR-L3 and CDR-H3 sequences.
   Sizes can either be distributed uniformly or according to the human repertoire;
5. Model+Design with macromolecular modeling software all the L3s against all the framework. The VHs will all have the same CDR-H3 sequence for this modeling step;
6. For each VH−VL pair, select best scoring (according to the macromolecular modeling software energy function) X L3 sequences L3₁ . . . L3ₓ;
7. Run another design/modeling round, all CDR-H3s in the database against VH+VL+L3ᵢ, i=1 . . . X (All the CDR-L3s that were selected for each VH+VL pair in the previous step);
8. Select best scoring K CDR-H3s for each L3ᵢ;
9. Model/Design with macromolecular modeling software all possible point mutations on the selected K H3s. For each H3, collect M best scoring point mutations;
10. Repeat point mutation step for all selected L3s+VH+VL, collect C best free energy approximation scoring mutations for each;
11. Optionally, fix/remove immunogenic antibodies and motifs that should affect developability; and
12. At the end of the process, there should be X*K*M*C³*N antibody sequences for synthesis.

### Example 3

In another embodiment, the method for generating a polypeptide library include the following steps (See FIG. 4):
1. Screen human VH and VL pairings for good developability properties (See FIG. 10);
2. Sort VH−VL pairs according to the above parameters and a weighting vector (provide a weight for each of the parameters above);
3. Select top N ranking VH−VL pairs to serve as the basis (aka framework) for the antibody library;
4. Choose a data set of CDR-L3 and CDR-H3 sequences.

Sizes can either be distributed uniformly or according to the human repertoire;
5. Let |DB _{H3}|=R, |DB _{L3}|=T. Graft (See FIG. 2) each of the CDR-H3 and CDR-L3 from the data set on top of each of the selected frameworks (Cross product (VH+VL)×[H3_{1 . . . R}]×[L3_{1 . . . T}]);
6. Model+Design with macromolecular modeling software to obtain free energy estimates for each of the molecules
   a. Optionally, include in the energy function of the macromolecular modeling software a term that should penalize immunogenic sequences (see, e.g., King et al., PNAS (2014) 111(23):8577-82, which is incorporated by reference herein)
   b. Optionally, include in the energy function of the macromolecular modeling software a term that should penalize motifs that should have negative effect on developability (See FIG. 10 for a list);
7. Rank end products by free energy estimates; and
8. For each VH−VL pair, Select top K molecules for synthesis.

### Example 4

In another embodiment, the method for generating a polypeptide library include the following steps (See FIG. 5):
1. Screen human VH and VL pairings for good developability properties (See FIG. 10);
2. Sort VH−VL pairs according to the above parameters and a weighting vector (provide a weight for each of the parameters above);
3. Select top N ranking VH−VL pairs to serve as the basis (aka framework) for the antibody library;
4. Choose a data set of CDR-L3 and CDR-H3 sequences.

Sizes can either be distributed uniformly or according to the human repertoire;
5. Model+Design with macromolecular modeling software all the L3s against all the framework. The VHs will all have the same CDR-H3 sequence for this modeling step;
6. For each VH−VL pair, select best scoring (according to the macromolecular modeling software energy function) X L3 sequences L3₁ . . . L3ₓ;
7. Run another design/modeling round, all CDR-H3s in the database against VH+VL+L3ᵢ, i=1 . . . X (All the CDR-L3s that were selected for each VH+VL pair in the previous step)
   a. Optionally, include in the energy function of the macromolecular modeling software a term that should penalize immunogenic sequences (see, e.g., King et al., PNAS (2014) 111:8577)
   b. Optionally, include in the energy function of the macromolecular modeling software a term that should penalize motifs that should have negative effect on developability (See FIG. 10 for a list);
8. Select best scoring K CDR-H3s for each L3ᵢ;
9. Model/Design with macromolecular modeling software all possible point mutations on the selected K H3s. For each H3, collect M best scoring point mutations;
10. Repeat point mutation step for all selected L3s+VH+VL, collect C best free energy approximation scoring mutations for each; and
11. At the end of the process, there should be X*K*M*C³*N antibody sequences for synthesis.

### Example 5

Embodiments of this invention utilize computational processing power to compute optimal antibody molecules that comprise the library (i.e., antibodies that are developable, stable and composed of human sequences). Given a computer system and macromolecular modeling software that is able to approximate the free energy of a protein molecule (aka free energy score, and/or score may be used interchangeably). In another embodiment, the method for generating a polypeptide library include one or more steps for updating PSSMs for next library from NGS data of well expressing VH/VLs after diversity amplification. In one aspect, the PSSM refinement includes the following steps (See FIG. 6).
1. Upon library construction, insert library to a display system such as yeast display or phage display
2. Use FACS to sort the library for well expressing polypeptides
3. Deep sequence using miSeq or equivalent method the well expressing population
4. Align the sequenced results and obtain log ratio of occurrences of point specific mutation generated by the diversity amplification
5. Form a new PSSM from the log ratios or incorporate the log ratios in an already existing PSSM

Having described preferred embodiments of the invention with reference to the accompanying drawings, it is to be understood that the invention is not limited to the precise embodiments, and that various changes and modifications may be effected therein by those skilled in the art without departing from the scope or spirit of the invention as defined in the appended claims.

What is claimed is:

1. A computer implemented method for generating a library of polypeptides or antibodies, the method comprising:
obtaining a first amino acid sequence of a complementarity determining region (CDR) associated with a heavy chain and a second amino acid sequence of a CDR associated with a light chain from a database of CDR sequences;
obtaining one or more variable heavy (VH) and variable light (VL) structural framework (VH/VL) pairs, wherein each of said pairs having one or more predetermined developability properties that facilitate for screening antibodies; and
analyzing said amino acid sequences and said VH/VL pairs with the use of a macromolecular algorithmic unit to generate one or more structures.

2. The method of claim 1, wherein said first amino acid sequence is H3 sequence of CDR3.

3. The method of claim 1, wherein said first amino acid sequence is L3 sequence of CDR3.

4. The method of claim 1, wherein said database is a CDR3 sequence database.

5. The method of claim 1, wherein said one or more predetermined developability properties facilitate for selecting one or more VH/VL pairs.

6. The method of claim 1, wherein at least one of said one or more predetermined developability properties is immunogenicity.

7. The method of claim 1, wherein at least one of said one or more predetermined developability properties is expression rate (mg/L), relative display rate, thermal stability (Tₘ), aggregation propensity, serum half-life, immunogenicity, or viscosity.

8. The method of claim 1, wherein said macromolecular algorithmic unit evaluates the amino acid sequence of H3 loop, L3 loop, or a combination thereof.

9. The method of claim 1, wherein said macromolecular algorithmic unit modifies or optimizes the amino acid sequence of H3 loop, L3 loop, or a combination thereof, based on a Point Specific Scoring Matrix (PSSM) and said one or more VH/VL pairs.

10. The method of claim 9, wherein the PSSM is based on sequence data from well expressing VH/VLs after diversity amplification.

11. The method of claim 10, wherein the PSSM is derived from the sequence data by aligning the sequences from the well expressing VH/VLs after diversity amplification, and obtaining a log ratio of occurrences of point specific mutation generated by the diversity amplification.

12. The method of claim 1, wherein said one or more seed structures are generated based on an energy function of H3 loop, L3 loop, said one or more VH/VL pairs or a combination thereof.

13. The method of claim 1, wherein said one or more seed structures are generated based on humanization of said structures.

14. The method of claim 1, wherein the step of analyzing optionally comprising analyzing one or more residues in the H3 or L3 loops to determine a mutation based on a Point Specific Scoring Matrix (PSSM) or a probability threshold and evaluate an energy score.

15. The method of claim 14, wherein the PSSM is based on sequence data from well expressing VH/VLs after diversity amplification.

16. The method of claim 15, wherein the PSSM is derived from the sequence data by aligning the sequences from the well expressing VH/VLs after diversity amplification, and obtaining a log ratio of occurrences of point specific mutation generated by the diversity amplification.

17. The method of claim 1, wherein the step of analyzing comprising removing immunogenic motifs.

18. The method of claim 1, wherein the step of analyzing comprising removing one or more motifs with negative effects on one or more predetermined developability properties.

19. A system for generating a library of polypeptides or antibodies, the system comprising:
a complementarity determining region (CDR) unit that facilitates obtaining a first amino acid sequence of a CDR associated with a heavy chain and a second amino acid sequence of a CDR associated with a light chain from a database of CDR sequences;
a framework unit that facilitates obtaining one or more variable heavy (VH) and variable light (VL) structural framework (VH/VL) pairs, wherein each of said pairs having one or more predetermined developability properties that facilitate for screening antibodies; and
an analysis unit that facilitates analyzing said amino acid sequences and said VH/VL pairs with the use of a macromolecular algorithmic unit to generate one or more structures.

20. The system of claim 19, wherein said first amino acid sequence is H3 sequence of CDR3.

21. The system of claim 19, wherein said first amino acid sequence is L3 sequence of CDR3.

22. The system of claim 19, wherein said database is a CDR3 sequence database.

23. The system of claim 19, wherein said one or more predetermined developability properties facilitate for selecting one or more VH/VL pairs.

24. The system of claim 19, wherein at least one of said one or more predetermined developability properties is immunogenicity.

25. The system of claim 19, wherein at least one of said one or more predetermined developability properties is expression rate (mg/L), relative display rate, thermal stability (Tₘ), aggregation propensity, serum half-life, immunogenicity, or viscosity.

26. The system of claim 19, wherein said macromolecular algorithmic unit evaluates the amino acid sequence of H3 loop, L3 loop, or a combination thereof.

27. The system of claim 19, wherein said macromolecular algorithmic unit modifies or optimizes the amino acid sequence of H3 loop, L3 loop, or a combination thereof, based on a Point Specific Scoring Matrix (PSSM) and said one or more VH/VL pairs.

28. The method of claim 27, wherein the PSSM is based on sequence data from well expressing VH/VLs after diversity amplification.

29. The method of claim 28, wherein the PSSM is derived from the sequence data by aligning the sequences from the well expressing VH/VLs after diversity amplification, and obtaining a log ratio of occurrences of point specific mutation generated by the diversity amplification.

30. The system of claim 19, wherein said one or more structures are generated based on an energy function of H3 loop, L3 loop, said one or more VH/VL pairs or a combination thereof.

31. The system of claim 19, wherein said one or more structures are generated based on humanization of said structures.

32. The system of claim 19, wherein said analysis unit optionally analyzes one or more residues in the H3 or L3 loops to determine a mutation based on a Point Specific Scoring Matrix (PSSM) or a probability threshold and evaluate an energy score.

33. The method of claim 32, wherein the PSSM is based on sequence data from well expressing VH/VLs after diversity amplification.

34. The method of claim 33, wherein the PSSM is derived from the sequence data by aligning the sequences from the well expressing VH/VLs after diversity amplification, and obtaining a log ratio of occurrences of point specific mutation generated by the diversity amplification.

35. The system of claim 19, wherein said analysis unit optionally removes immunogenic motifs.

36. The system of claim 19, wherein said analysis unit optionally removes one or more motifs with negative effects on one or more predetermined developability properties.

37. A computer readable storage media comprising instructions to perform a method for generating a library of polypeptides or antibodies, the method comprising:
obtaining a first amino acid sequence of a complementarity determining region (CDR) associated with a heavy chain and a second amino acid sequence of a CDR associated with a light chain from a database of CDR sequences;
obtaining one or more variable heavy (VH) and variable light (VL) structural framework (VH/VL) pairs, wherein each of said pairs having one or more predetermined developability properties that facilitate for screening antibodies; and
analyzing said amino acid sequences and said VH/VL pairs with the use of a macromolecular algorithmic unit to generate one or more structures.
